(19) United States
(12) Patent Application Publication
(10) Pub. No.: US 2025/0180091 A1
(43) Pub. Date: Jun. 5, 2025

(54) DAMPING FORCE-VARIABLE SHOCK ABSORBER

(71) Applicant: HL MANDO CORPORATION, Pyeongtaek-si, Gyeonggi-do (KR)

(72) Inventor: Jaehyung KIM, Yongin-si (KR)

(21) Appl. No.: 18/845,297

(22) PCT Filed: Mar. 9, 2023
(86) PCT No.: PCT/KR2023/003223

§ 371 Date: Sep. 9, 2024

(30) Foreign Application Priority Data
Mar. 16, 2022 (KR) 10-2022-0032861

(51) Int. Cl. F16F 9/46; F16F 9/348

(52) U.S. Cl. CPC F16F 9/464; F16F 9/348; F16F 2228/066

(57) ABSTRACT

A damping force-variable shock absorber is disclosed. A damping force-variable shock absorber according to the present embodiment includes: a damping force control valve; and a solenoid for driving the damping force control valve, wherein the solenoid includes: a case having an opening formed through one side thereof to communicate with the damping force control valve; a coil provided in the case and providing a magnetic field; a rod moving along the longitudinal direction of the case and having one end extending through the opening; a plunger for holding the rod and moving the rod along the longitudinal direction under the influence of a magnetic field; a core through which one end of the rod extends to support the rod; and a guide disposed at the side of the other end of the rod to be fixed to the case and having a tapered sidewall formed at a lower part thereof.

### BACKGROUND

### Technical Field

The present disclosure relates to a damping force-variable shock absorber disposed in a vehicle to alleviate shock transmitted from the ground.

### Description of the Related Art

Generally, shock absorbers are installed in automobiles such as vehicles to improve ride comfort by absorbing and damping vibrations, shocks, and the like received from a road surface while driving. A shock absorber typically includes a cylinder and a piston rod that is disposed in the cylinder to be compressible and extensible. The cylinder and piston rod are each coupled to a vehicle body, wheels, or axles.

When damping force is set low, a shock absorber may absorb vibrations caused by irregularities on a road surface while driving to improve ride comfort, while when the damping force is set high, changes in the posture of a vehicle body are suppressed and steering stability is improved.

Here, a shock absorber includes a cylinder and a piston rod disposed in the cylinder to be reciprocated, and the cylinder and piston rod are each coupled to a vehicle body, wheels, or axles. When damping force is set low, the shock absorber may absorb vibrations caused by irregularities on a road surface while driving to improve ride comfort, while when the damping force is set high, changes in the posture of the vehicle body are suppressed and steering stability is improved.

In this way, a shock absorber capable of adjusting the damping force characteristics according to road surfaces and driving conditions has been developed, but the conventional shock absorber has a complicated device structure, which has caused a large damping force distribution during mass production, and in particular, there has been a problem that damping force increases due to unintended flow resistance in a high-speed zone.

Therefore, a damping force-variable shock absorber has been developed that can appropriately adjust damping force characteristics for improving ride comfort or steering stability depending on a road surface, driving condition, and the like by mounting a damping force-variable valve on one side of the shock absorber to properly adjust the damping force characteristics.

The damping force-variable shock absorber further includes a damping force-variable valve assembly for controlling the damping force. The damping force-variable valve assembly may convert the damping force into a hard mode in which a spool of a solenoid closes an auxiliary passage to generate high damping force, and a soft mode in which the spool opens the auxiliary passage to generate low damping force.

### BRIEF SUMMARY

### Technical Problem

An exemplary embodiment of the present disclosure is to provide a damping force-variable shock absorber that uses soft damping force when a low current is applied.

An exemplary embodiment of the present disclosure is to provide a variable shock absorber including a solenoid with a rod that moves down to a damping force control valve when a low current is applied.

### Technical Solution

According to one aspect of the present disclosure, a damping force-variable shock absorber includes a damping force control valve and a solenoid that drives the damping force control valve, in which the solenoid may include: a case having an opening formed through one side thereof to communicate with the damping force control valve; a coil that is disposed inside the case to supply a magnetic field; a rod that moves along a longitudinal direction of the case and has one end portion inserted through the opening; a plunger that holds the rod and moves the rod along the longitudinal direction under an influence of the magnetic field; a core through which the one end portion of the rod passes such that the rod is supported; and a guide that is disposed on another end portion of the rod to be fixed to the case and has a side wall formed in a tapered shape on a lower portion thereof.

A side surface of the core may have a cylindrical shape parallel to the longitudinal direction.

The core may have an insertion portion that extends through the opening toward the damping force control valve.

The solenoid may further include a spring that applies a restoring force to the plunger, and the plunger may have a stop protrusion corresponding to a width of one end portion of the spring.

The guide may have a stop protrusion corresponding to a width of another end portion of the spring.

The case may have a support portion that extends inward in a circumferential direction to surround outer surfaces of the plunger and the core.

The solenoid may further include a first support member that is interposed between the core and the one end portion of the rod.

The solenoid may further include a second support member that is interposed between the guide and another end portion of the rod.

When a current corresponding to a first section of a low current is applied to the coil, attractive force may act between the plunger and the core, and the rod may move together with the plunger in a direction toward the core to actuate the damping force control valve in a soft mode.

When a current corresponding to a second section greater than the first section is applied to the coil, repulsive force may act between the plunger and the core, and the rod may move together with the plunger in a direction away from the core to actuate the damping force control valve in a hard mode.

According to another aspect of the present disclosure, a damping force-variable shock absorber may include a damping force control valve, and a solenoid having a rod that moves toward inside of the damping force control valve when a current corresponding to a first section of a low current is applied. The damping force control valve may include: a piston in which a main path and a bypass path are defined; a pair of main retainers that are disposed above and below the piston, respectively, and each have a connection passage to be connected to the main passage; a pair of pilot housings that are disposed on opposite surfaces of the main retainers, respectively, to form pilot chambers in directions facing each other; a pair of pilot valves that are disposed between the pilot chambers and the main retainers and are open during a stroke such that the connection passage and a compression chamber or a rebound chamber are connected to each other; a pair of check valves that are disposed on opposite surfaces of the pilot housings to open and close the pilot chambers; a spool that moves in conjunction with movement of the rod and is inserted through centers of the main retainers, the pilot housings, and the pilot valves; a spool guide that guides the spool and branches the connection passage to the compression chamber or the rebound chamber; and a pair of disks that are supported between the main retainers and the pilot valves, respectively.

The damping force control valve may operate in a soft mode in the first section. The second section may correspond to a current higher than the first section, and the damping force control valve may operate in a hard mode in the second section.

The main path may be formed along the rebound chamber, a main passage, the connection passage, the disk, and the compression chamber, and the bypass path may be formed along the disk, an inside of the spool guide, the main passage, and the compression chamber.

The rod may move the spool downward to open the bypass path in the soft mode.

The rod may move the spool upward to close the bypass path in the hard mode.

At least one passage may be formed through an outer peripheral surface of the spool guide in a radial direction.

The passage formed through the outer peripheral surface of the spool guide may include a first passage that is formed in a direction toward the compression chamber with respect to the piston, such that a spool receiving space for receiving the spool and the compression chamber are connected to each other.

The passage formed through the outer peripheral surface of the spool guide may include a second passage that is formed in the direction toward the compression chamber with respect to the first passage, such that the spool receiving space and the connection passage are connected to each other.

The passage formed through the outer peripheral surface of the spool guide may include a third passage that is formed in a direction toward the rebound chamber with respect to the piston, such that a spool receiving space for receiving the spool and the rebound chamber are connected to each other.

The passage formed through the outer peripheral surface of the spool guide may include a fourth passage that is formed in the direction toward the rebound chamber with respect to the third passage, such that the spool receiving space and the connection passage are connected to each other.

### Advantageous Effects

A damping force-variable shock absorber according to an exemplary embodiment of the present disclosure can generate two modes of damping force (soft/hard) depending on power applied to a solenoid, thereby improving ride comfort and steering stability compared to the related art.

A damping force-variable shock absorber according to an exemplary embodiment of the present disclosure can operate in a soft mode when a low current is applied, thereby reducing power consumption.

A damping force-variable shock absorber according to an exemplary embodiment of the present disclosure can constantly control a displacement of a rod when a solenoid controls damping force from a soft mode to a hard mode, thereby achieving very high precision for damping force control.

### DESCRIPTION OF THE SEVERAL VIEWS OF THE DRAWINGS

FIG. 1 is a diagram illustrating a damping force-variable shock absorber according to an exemplary embodiment of the present disclosure.

FIG. 2 is an enlarged view illustrating a solenoid of a damping force-variable shock absorber according to an exemplary embodiment of the present disclosure.

FIG. 3 is a cross-sectional view illustrating a rebound flow of a working fluid in a soft mode of a damping force-variable shock absorber according to an exemplary embodiment of the present disclosure.

FIG. 4 is a cross-sectional view illustrating a compression flow of a working fluid in a soft mode of a damping force-variable shock absorber according to an exemplary embodiment of the present disclosure.

FIG. 5 is a cross-sectional view illustrating a rebound flow of a working fluid in a hard mode of a damping force-variable shock absorber according to an exemplary embodiment of the present disclosure.

FIG. 6 is a cross-sectional view illustrating a compression flow of a working fluid in a hard mode of a damping force-variable shock absorber according to an exemplary embodiment of the present disclosure.

FIG. 7 is a cross-sectional view for explaining a displacement of a rod in a damping force-variable shock absorber according to an exemplary embodiment of the present disclosure.

### DETAILED DESCRIPTION

Hereinafter, exemplary embodiments of the present disclosure will be described in detail with reference to the accompanying drawings. Exemplary embodiments introduced below are provided as examples so that the idea of the present disclosure can be sufficiently conveyed to those skilled in the art. The present disclosure is not limited to those exemplary embodiments described below and may be embodied in other forms. In order to clearly explain the present disclosure, parts not related to the description are omitted from the drawings, and in the drawings, widths, lengths, thicknesses, etc., of components may be exaggerated for convenience. Like reference numerals refer to like components throughout the specification.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

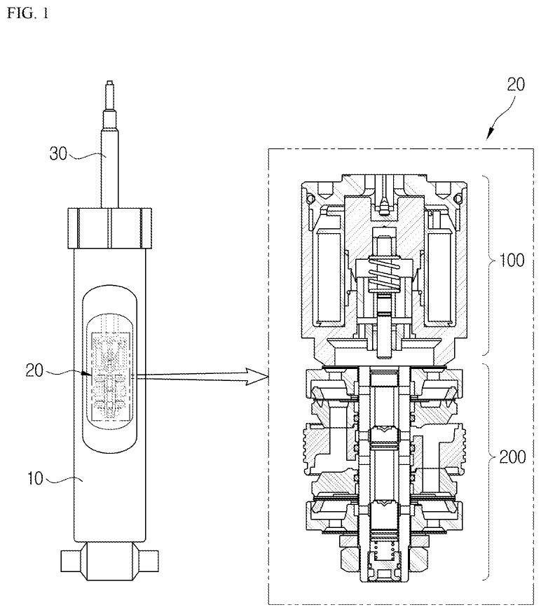

FIG. 1 is a diagram illustrating a damping force-variable shock absorber according to an exemplary embodiment of the present disclosure.

Referring to FIG. 1, a damping force-variable shock absorber according to an exemplary embodiment of the present disclosure includes a tube unit 10 disposed in the form of a cylinder and filled with fluid, a valve unit 20 disposed in the tube unit 10 and selectively open and closed to perform a compression or rebound stroke of the fluid, and a piston rod 30 inserted into one side of the tube unit 10.

The valve unit 20 includes a damping force control valve 200 and a solenoid 100 that actuates the damping force control valve 200.

Referring to FIG. 1, a direction parallel to a central axis of the damping force-variable shock absorber is defined as a “longitudinal direction,” and a direction perpendicular to the longitudinal direction and perpendicular to the central axis of the shock absorber is defined as a “circumferential direction.” Based on the disposition of the solenoid 100 and the damping force control valve 200 illustrated in FIG. 1, a movement in a direction from the solenoid 100 toward the damping force control valve 200 is defined as “moving downward or descending,” and a movement in a direction that the solenoid 100 moves away from the damping force control valve 200 is defined as “moving upward or ascending.”

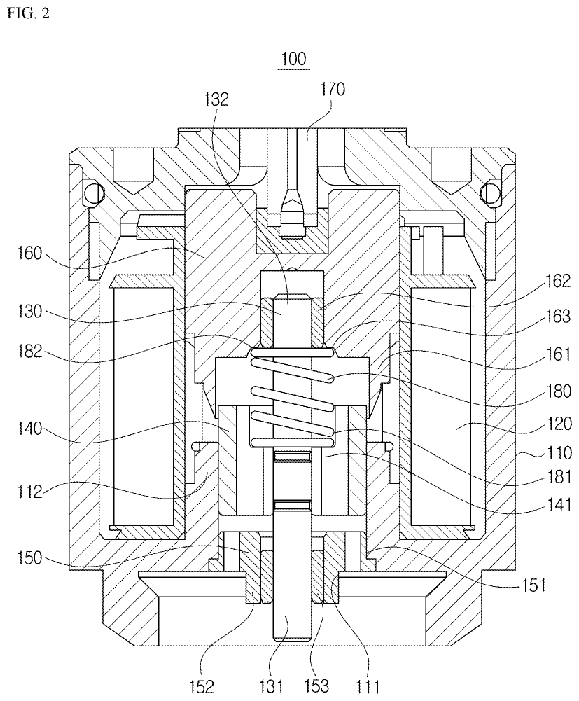

FIG. 2 is an enlarged view illustrating a solenoid of a damping force-variable shock absorber according to an exemplary embodiment of the present disclosure.

The solenoid 100 may include a case 110 having an opening 111 in one side to communicate with the damping force control valve 200, a coil 120 disposed inside the case 110 and supplying a magnetic field, a rod 130 moving in a longitudinal direction and having one end portion 131 passing through the opening 111, a plunger 140 holding the rod 130 and moving the rod 130 along the longitudinal direction under the influence of the magnetic field, a core 150 through which the one end portion 131 of the rod 130 is inserted so that the rod 130 is supported, and a guide 160 disposed on another end portion 132 of the rod 130 and fixed to the case 110.

When a current is applied from a vehicle through a wire 170 inside the piston rod 30, a magnetic field flows along magnetic bodies, such as the case 110, the guide 160, the plunger 140, the core 150, and the like, which are disposed adjacent to the coil 120 inside the solenoid 100. Attraction force may be generated between these magnetic bodies. Among others, only the plunger 140 may move together with the rod 130.

The guide 160 may have a side wall 161 that is tapered. The side wall 161 may be formed on a bottom portion of the guide 160, and a space capable of accommodating the plunger 140 may be defined in a central portion of the side wall 161. The side wall 161 may substantially have a conical shape.

Corresponding to the shape of the guide 160, a side surface 151 of the core 150 may have a cylindrical shape to be in parallel to the longitudinal direction. That is, the core 150 does not have a conical shape, unlike the side wall 161.

As such, the core 150 may not be formed in the conical shape, but instead, the lower portion of the guide 160 may have the conical shape. The guide 160 is located on one side of the plunger 140 and the core 150 is located on another side of the plunger 140. Weak attractive force is generated in the circumferential direction and strong attractive force is generated in the longitudinal direction between the guide 160 and the plunger 140. On the other hand, strong attractive force is generated in the circumferential direction and weak attractive force is generated in the longitudinal direction between the plunger 140 and the core 150. Accordingly, magnetic force becomes strong and a flow of magnetic field becomes smooth as the plunger 140 and the guide 160 get close to each other. This makes the plunger 140 move upward together with the rod 130.

The core 150 may have an insertion portion 152 extending therefrom toward the damping force control valve through the opening 111. A first support member 153 may be interposed between the insertion portion 152 of the core 150 and the one end portion 131 of the rod 130. The first support member 153 may be made of an elastic material, such that the core 150 can smoothly move in the longitudinal direction.

A space in which the another end portion 132 of the rod 130 can be accommodated may be formed in an upper portion of the guide 160. When the rod 130 moves upward along the longitudinal direction, the another end portion 132 of the rod 130 further enters this space. A second support member 162 may be interposed between the guide 160 and the another end portion 132 of the rod 130. The second support member 162 may be made of an elastic material, such that the core 150 can smoothly move in the longitudinal direction.

A spring 180 may be disposed to surround the rod 130. The spring 180 may apply restoring force to the plunger 140. A width of the spring 180 in the circumferential direction may be slightly greater than a radius of the rod 130 so that the spring 180 can be accommodated inside the plunger 140.

A stop protrusion 141 corresponding to a width of one end portion 181 of the spring 180 may be formed inside the plunger 140. A stop protrusion 163 corresponding to a width of another end portion 182 of the spring 180 may be formed inside the guide 160. In this way, since upper and lower ends of the spring 180 are supported by the stop protrusions, the spring 180 can provide stably restoring force to the plunger 140 without being shaken in the circumferential direction.

The case 110 may have a support portion 112 that extends inward in the circumferential direction and surrounds outer surfaces of the plunger 140 and the core 150. The support portion 112 may restrict the circumferential movement of the plunger 140 and the core 150, and the plunger 140 may move smoothly along the longitudinal direction in a space defined by the support portion 112.

Hereinafter, the operations of the damping force control valve 200 and the solenoid 100 illustrated in FIGS. 1 and 2 will be described.

When a current belonging to a first section (for example, 0 to 0.3 A), as a low current, is applied to the coil 120 of the damping force-variable shock absorber, attractive force may act between the plunger 140 and the core 150, and the rod 130 may move in a direction toward the core 150 together with the plunger 140, thereby actuating a soft mode in the damping force control valve 200.

When a current belonging to a second section (for example, 0.3 to 1.6 A), greater than the first section, is applied to the coil 120 of the damping force-variable shock absorber, repulsive force may act between the plunger 140 and the core 150, and the rod 130 may move in a direction away from the core 150 together with the plunger 140, thereby actuating a hard mode in the damping force control valve 200.

Unlike the method described above, there may be an electronic control shock absorber (electronic control system (ECS)) that implements soft mode damping force when a high current is applied and hard mode damping force when a low current is applied. However, according to the exemplary embodiment, a reverse type current control structure can be provided in that the soft mode damping force is implemented when the current belonging to the first section as the low current is applied and the hard mode damping force is implemented when the current belonging to the second section as the high current is applied.

Such a reverse type damping force control may provide an advantage of reducing power consumption. Although it may vary depending on a driver's personality, most drivers seek comfortable driving experiences, so a soft mode operation is mostly performed during a normal vehicle behavior. In other words, if a current implementing the soft mode changes from 1.6 A to 0.3A, for example, a current consumption can be reduced by about 86% from 45 W to 6.3 W. This may contribute to achieving a goal of being eco-friendly, which is a currently urgent challenge for an automobile industry.

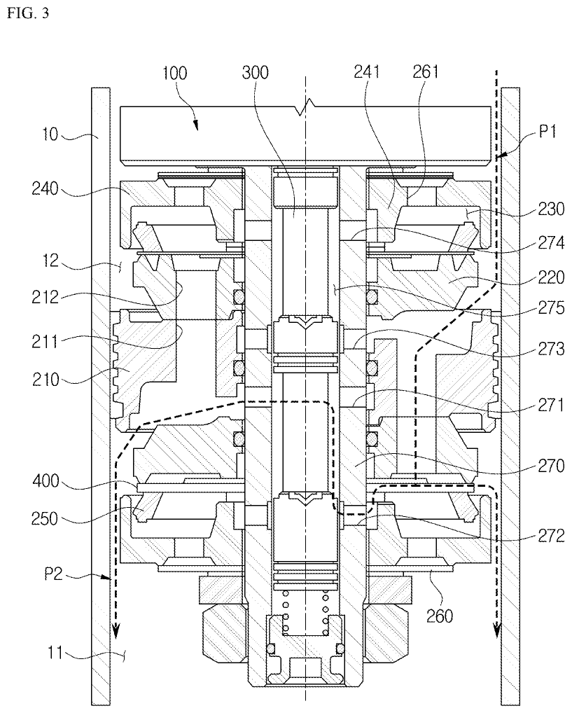

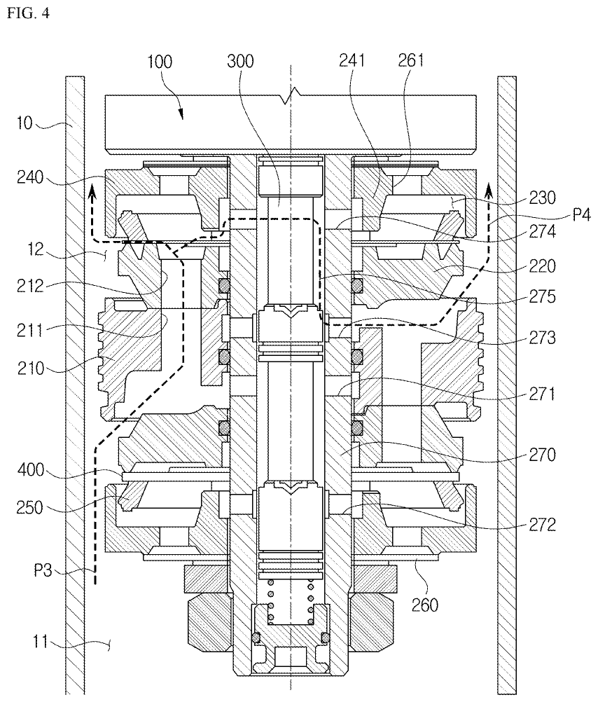

FIG. 3 is a cross-sectional view illustrating a rebound flow of a working fluid in a soft mode of a damping force-variable shock absorber according to an exemplary embodiment of the present disclosure. FIG. 4 is a cross-sectional view illustrating a compression flow of a working fluid in a soft mode of a damping force-variable shock absorber according to an exemplary embodiment of the present disclosure.

The damping force control valve 200 includes a piston 210 that is coupled to the piston rod 30 to divide the inside of the tube unit 10 into a compression chamber 11 and a rebound chamber 12 and has a main passage 211 formed therein, a pair of main retainers 220 that are disposed above and below the piston 210, respectively, and each has a connection passage 212 to be connected to the main passage 211, a pair of pilot housings 240 that are disposed on opposite surfaces of the main retainers 220 to form pilot chambers 230 in directions facing each other, respectively, a pair of pilot valves 250 that are disposed between the pilot chambers 230 and the main retainers 220 and is open during a stroke to connect the connection passage 212 and the compression chamber 11 or the rebound chamber 12, a pair of check valves 260 that are disposed on opposite surfaces of the pilot housings 240 to open and close the pilot chambers 230, a spool 300 that passes through centers of the main retainers 220, the pilot housings 240, and the pilot valves 250, a spool guide 270 that guides the spool 300 and branches the connection passage 212 to the compression chamber 11 or the rebound chamber 12, and a pair of disks 400 supported between the main retainers 220 and the pilot valves 250, respectively. The spool 300 may move in conjunction with the movement of the rod 130 illustrated in FIG. 2.

A check valve passage 261 is formed vertically through the pilot housing 240, so that the pilot chamber 230 communicates with the compression chamber 11 or the rebound chamber 12. The pilot chamber 230 is formed in an open state in a direction toward the main retainer 220, and the pilot valve 250 is disposed within the pilot chamber 230 to be movable up and down. Additionally, a support portion 241 extending upward is formed in the pilot housing 240 to support the disk 400.

A first passage 271, a second passage 272, a third passage 273, and a fourth passage 274 may be formed through an outer peripheral surface of the spool guide 270 in a radial direction. The first passage 271 is formed in a direction toward the compression chamber 11 with respect to the piston 210, connects a spool receiving space 275 and the compression chamber 11, and is open when the spool 300 moves to an open position. The second passage 272 is formed in a direction toward the compression chamber 11 with respect to the first passage 271. When compression and rebound strokes are performed after the spool 300 has moved to the open position, the spool receiving space 275 which is the inside of the spool guide 270 and the connection passage 212 are connected through the second passage 272. The third passage 273 is formed in a direction toward the rebound chamber 12 with respect to the piston 210, connects the spool receiving space 275 and the rebound chamber 12, and is open when the spool 300 moves to the open position. The fourth passage 274 is formed in a direction toward the rebound chamber 12 with respect to the third passage 273. When compression and rebound strokes are performed after the spool 300 has moved to the open position, the spool receiving space 275 and the connection passage 212 are connected through the fourth passage 274.

Referring to FIGS. 1 and 2, when a current belonging to the first section as the low current is applied to the solenoid 100, the rod 130 moves toward the inside of the damping force control valve 200. In the first section, the damping force control valve operates in a soft mode. The solenoid 100 is coupled to the piston rod 30 located inside the tube unit 10 and operates electrically to lower (descend) the plunger 140, and the rod 130, which moves together with the plunger 140, moves the spool 300 downward to open and close a bypass passage.

The rod 130 inside the solenoid 100 has a structure of being in contact with the spool 300 inside the damping force control valve 200. When the current corresponding to the first section is applied to the solenoid 100, the rod 130 moves downward so that the spool 300 moves downward. As the spool 300 moves downward, a bypass path is open in addition to a main path. At low speed, fluid (not illustrated) flows only through the bypass path, generating a low level of damping force. On the other hand, at medium/high speed, the disk 400 is tilted, generating damping force through the main passage.

Referring to FIG. 3, in a soft mode in which a low current is applied, a rebound flow is generated along the main path P1 and the bypass path P2, and the fluid (not illustrated) generally forms a flow from the rebound chamber 12 to the compression chamber 11. The main path PI may be formed along the rebound chamber 12, the main passage 211, the connection passage 212, the disk 400, and the compression chamber 11, and the bypass path P2 may be formed along the disk 400, the second passage 272, the spool receiving space 275, the first passage 271, the main passage 211, and the compression chamber 11.

Referring to FIG. 4, in a soft mode in which a low current is applied, a compression flow is generated along the main path P3 and the bypass path P4, and a fluid (not illustrated) generally forms a flow from the compression chamber 11 to the rebound chamber 12. The main path P3 may be formed along the compression chamber 11, the main passage 211, the connection passage 212, the disk 400, and the rebound chamber 12, and the bypass path P4 may be formed along the disk 400, the fourth passage 274, the spool receiving space 275, the third passage 273, the main passage 211, and the rebound chamber 12.

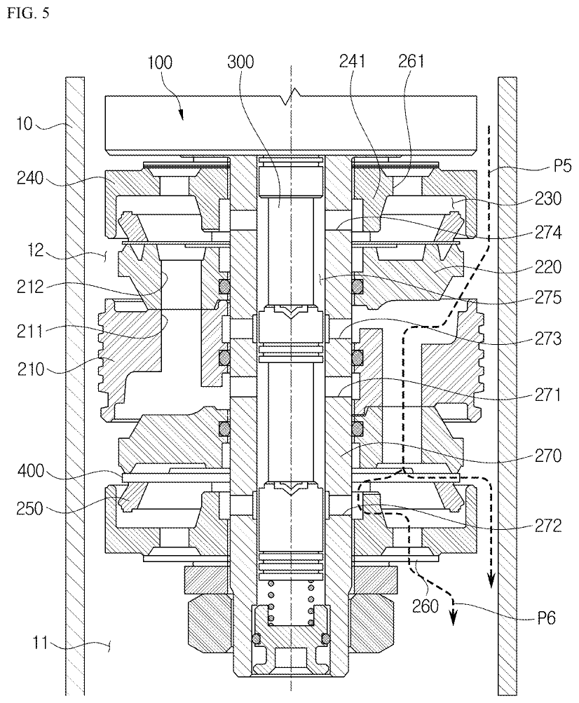

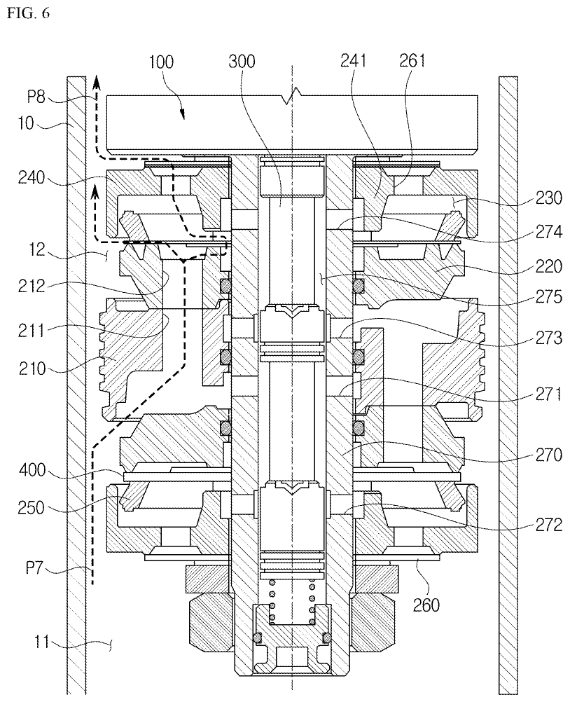

FIG. 5 is a cross-sectional view illustrating a rebound flow of a working fluid in a hard mode of a damping force-variable shock absorber according to an exemplary embodiment of the present disclosure. FIG. 6 is a cross-sectional view illustrating a compression flow of a working fluid in a hard mode of a damping force-variable shock absorber according to an exemplary embodiment of the present disclosure.

The second section corresponds to a current higher than the first section, and the damping force control valve 200 operates in a hard mode in the second section. Referring to FIG. 2, in the hard mode, the rod 130 moves the spool 300 upward to close the bypass path.

When a high current corresponding to the second section is applied to the solenoid 100, the rod 130 of the solenoid moves relatively from a lower position to an upper position, and the spool 300 also moves upward together with the rod 130. In this case, the bypass path is closed, and a passage is formed below (in the pilot chamber of) the pilot valve 250 in addition to the main passage. At low speed, pressure of the pilot chamber 230 is low, but at medium/high speed, the pressure of the pilot chamber 230 may increase, thereby strengthening rigidity of the disk 400 and generating high damping force.

Referring to FIG. 5, in a hard mode in which a high current is applied, a rebound flow is generated along a main path P5 and a back pressure path P6, and a fluid (not illustrated) generally forms a flow from the rebound chamber 12 to the compression chamber 11. The main path P5 may be formed along the rebound chamber 12, the main passage 211, the connection passage 212, the disk 400, and the compression chamber 11, and the back pressure path P6 may be formed along the inner peripheral surface of the disk 400, the outer peripheral surface of the spool guide 270, and the pilot chamber 230.

Referring to FIG. 6, in a hard mode in which a high current is applied, a rebound flow is generated along a main path P7 and a back pressure path P8, and a fluid (not illustrated) generally forms a flow from the compression chamber 11 to the rebound chamber 12. The main path P7 may be formed along the compression chamber 11, the main passage 211, the connection passage 212, the disk 400, and the rebound chamber 12, and the back pressure path P8 may be formed along the inner peripheral surface of the disk 400, the outer peripheral surface of the spool guide 270, and the pilot chamber 230.

In this way, when the working fluid moves into the pilot chamber 230 along the back pressure path P6, P8, pressure of the working fluid may be transmitted to the pilot valve 250, and during this process, damping force may increase.

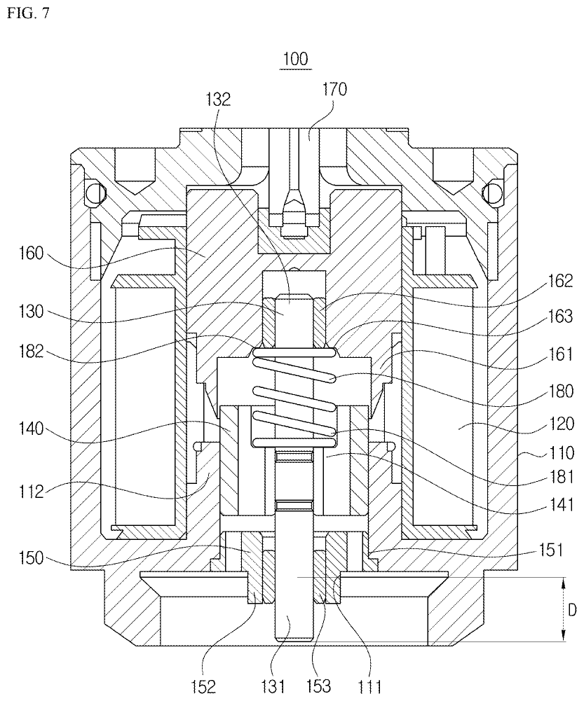

FIG. 7 is a cross-sectional view for explaining a displacement of a rod in a damping force-variable shock absorber according to an exemplary embodiment of the present disclosure.

Referring to FIG. 3, when the damping force control valve variably controls damping force from a soft mode to a hard mode, the factor that plays a key role is the position of the spool 300, and the factor that determines the position of the spool 300 is the position of the rod 130 of the solenoid. Therefore, compared to a shock absorber of a type that uses a high current in a soft mode, in order to implement the same mode and the same damping force, it is necessary that the displacement of the rod when a high current corresponding to the second section is applied to the corresponding type of the shock absorber is equal to the displacement of the rod when a low current corresponding to the first section is applied to the type of the shock absorber according to the exemplary embodiment of the present disclosure.

In other words, if the comparative embodiment is a type of shock absorber that uses a high current in a soft mode, the displacement when a low current is applied in the comparative embodiment may be the same as the displacement D when a high current is applied in the exemplary embodiment of the present disclosure, and the displacement when the high current is applied in the comparative embodiment may be the same as the displacement D when a low current is applied in the exemplary embodiment.

Therefore, the damping force-variable shock absorber according to the exemplary embodiment of the present disclosure may form two modes of damping force (soft damping force/hard damping force) when a low current and a high current are applied, respectively, thereby improving ride comfort and steering stability compared to the related art, and further reducing power consumption.

So far, the present disclosure has been described with reference to the exemplary embodiment illustrated in the accompanying drawings, but this is merely illustrative. It will be understood by those skilled in the art that variations and equivalent exemplary embodiments are realized from the exemplary embodiments. Therefore, the true scope of the present disclosure should be determined only by the appended claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A damping force-variable shock absorber comprising a damping force control valve and a solenoid that actuates the damping force control valve,
wherein the solenoid includes:
a case that has an opening in one side thereof to communicate with the damping force control valve;
a coil that is disposed inside the case to supply a magnetic field;
a rod that moves along a longitudinal direction of the case and has one end portion inserted through the opening;
a plunger that holds the rod and moves the rod along the longitudinal direction under an influence of the magnetic field; and
a core through which the one end portion of the rod passes so that the rod is supported; and
a guide that is disposed on another end portion of the rod to be fixed to the case and has a side wall formed in a tapered shape on a lower portion thereof.

2. The damping force-variable shock absorber of claim 1, wherein a side surface of the core has a cylindrical shape in parallel to the longitudinal direction.

3. The damping force-variable shock absorber of claim 1, wherein the core has an insertion portion that extends through the opening toward the damping force control valve.

4. The damping force-variable shock absorber of claim 1, wherein the solenoid further includes a spring that applies a restoring force to the plunger, and
the plunger is provided with a stop protrusion corresponding to a width of one end portion of the spring.

5. The damping force-variable shock absorber of claim 4, wherein the guide is provided with a stop protrusion corresponding to a width of another end portion of the spring.

6. The damping force-variable shock absorber of claim 1, wherein the case is provided with a support portion that extends inward in a circumferential direction to surround outer surfaces of the plunger and the core.

7. The damping force-variable shock absorber of claim 1, wherein the solenoid further includes a first support member that is interposed between the core and the one end portion of the rod.

8. The damping force-variable shock absorber of claim 1, wherein the solenoid further includes a second support member that is interposed between the guide and the another end portion of the rod.

9. The damping force-variable shock absorber of claim 1, wherein when a current corresponding to a first section of a low current is applied to the coil, attractive force acts between the plunger and the core, and the rod moves together with the plunger in a direction toward the core to actuate the damping force control valve in a soft mode.

10. The damping force-variable shock absorber of claim 1, wherein when a current corresponding to a second section greater than a first section is applied to the coil,
repulsive force acts between the plunger and the core, and the rod moves together with the plunger in a direction away from the core to actuate the damping force control valve in a hard mode.

11. A damping force-variable shock absorber comprising a damping force control valve, and a solenoid having a rod that moves toward an inside of the damping force control valve when a current corresponding to a first section of a low current is applied,
wherein the damping force control valve includes:
a piston in which a main path and a bypass path are defined;
a pair of main retainers that are disposed above and below the piston and each have a connection passage to be connected to the main path;
a pair of pilot housings that are disposed on opposite surfaces of the main retainers, respectively, to form pilot chambers in directions facing each other;
a pair of pilot valves that are disposed between the pilot chambers and the main retainers and are open during a stroke such that the connection passage and a compression chamber or a rebound chamber are connected to each other;
a pair of check valves that are disposed on opposite surfaces of the pilot housings to open and close the pilot chambers;
a spool that moves in conjunction with movement of the rod and is inserted through centers of the main retainers, the pilot housings, and the pilot valves;
a spool guide that guides the spool and branches the connection passage to the compression chamber or the rebound chamber; and
a pair of disks that are supported between the main retainers and the pilot valves, respectively.

12. The damping force-variable shock absorber of claim 11, wherein the damping force control valve operates in a soft mode in the first section, and a second section corresponds to a current higher than the first section, and the damping force control valve operates in a hard mode in the second section.

13. The damping force-variable shock absorber of claim 11, wherein the main path is formed along the rebound chamber, a main passage, the connection passage, the disk, and the compression chamber, and
the bypass path is formed along the disk, an inside of the spool guide, the main passage, and the compression chamber.

14. The damping force-variable shock absorber of claim 12, wherein the rod moves the spool downward to open the bypass path in the soft mode.

15. The damping force-variable shock absorber of claim 12, wherein the rod moves the spool upward to close the bypass path in the hard mode.

16. The damping force-variable shock absorber of claim 11, wherein at least one passage is formed through an outer peripheral surface of the spool guide in a radial direction.

17. The damping force-variable shock absorber of claim 16, wherein the passage formed through the outer peripheral surface of the spool guide includes a first passage that is formed in a direction toward the compression chamber with respect to the piston, such that a spool receiving space for receiving the spool and the compression chamber are connected to each other.

18. The damping force-variable shock absorber of claim 17, wherein the passage formed through the outer peripheral surface of the spool guide includes a second passage that is formed in the direction toward the compression chamber with respect to the first passage, such that the spool receiving space and the connection passage are connected to each other.

19. The damping force-variable shock absorber of claim 16, wherein the passage formed through the outer peripheral surface of the spool guide includes a third passage that is formed in a direction toward the rebound chamber with respect to the piston, such that the spool receiving space for receiving the spool and the rebound chamber are connected to each other.

20. The damping force-variable shock absorber of claim 19, wherein the passage formed through the outer peripheral surface of the spool guide includes a fourth passage that is formed in the direction toward the rebound chamber with respect to the third passage, such that the spool receiving space and the connection passage are connected to each other.
